(19) United States
(12) Patent Application Publication
(10) Pub. No.: US 2026/0313588 A1
(43) Pub. Date: Oct. 8, 2026

(54) COMBINING POSITIONING-RELATED DATA

(71) Applicant: Nokia Technologies Oy, Espoo (FI)

(72) Inventors: Oana-Elena BARBU, Aalborg (DK); Dick CARRILLO MELGAREJO, Lappeenranta (FI); Sajad REZAIE, Aalborg (DK)

(21) Appl. No.: 19/478,876

(22) PCT Filed: Mar. 12, 2024
(86) PCT No.: PCT/FI2024/050104

§ 371 Date: Oct. 27, 2025

(30) Foreign Application Priority Data
May 9, 2023 (FI) 20235516

(51) Int. Cl. H04W 64/00; H04W 4/02; H04W 24/10

(52) U.S. Cl. CPC H04W 64/00; H04W 4/023; H04W 24/10

(57) ABSTRACT

Disclosed is a method comprising transmitting, to one or more candidate user equipments, a request for reporting one or more measurements suitable for evaluating similarity of propagation conditions of the one or more candidate user equipments and a first user equipment; receiving, from at least a subset of the one or more candidate user equipments, one or more reports indicating the one or more measurements or an availability of the one or more measurements; selecting, based at least on the one or more reports, at least one user equipment from the at least subset of the one or more candidate user equipments; receiving, from the at least one user equipment, positioning-related data that is complementary to one or more positioning data samples received from the first user equipment; and combining the positioning-related data with the one or more positioning data samples received from the first user equipment.

### FIELD

The following example embodiments relate to wireless communication and to positioning.

### BACKGROUND

Artificial intelligence or machine learning models may be used for estimating the position of a user equipment. Positioning data samples may be collected from the user equipment for training, updating, and/or monitoring the performance of the artificial intelligence or machine learning models. However, the user equipment may be moving, or in an area with poor coverage, or in an area with heavy network congestion, or in some other scenario, which may result in the positioning data samples provided by the user equipment being incomplete. Thus, it is desirable to improve the process of collecting the positioning data samples in order to cope with the incomplete positioning data samples.

### SUMMARY

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: transmit, to one or more candidate user equipments, a request for reporting one or more measurements suitable for evaluating similarity of propagation conditions of the one or more candidate user equipments and a first user equipment; receive, from at least a subset of the one or more candidate user equipments, one or more reports indicating the one or more measurements or an availability of the one or more measurements; select, based at least on the one or more reports, at least one user equipment from the at least subset of the one or more candidate user equipments; receive, from the at least one user equipment, positioning-related data that is complementary to one or more positioning data samples received from the first user equipment; and combine the positioning-related data received from the at least one user equipment with the one or more positioning data samples received from the first user equipment.

According to another aspect, there is provided an apparatus comprising: means for transmitting, to one or more candidate user equipments, a request for reporting one or more measurements suitable for evaluating similarity of propagation conditions of the one or more candidate user equipments and a first user equipment; means for receiving, from at least a subset of the one or more candidate user equipments, one or more reports indicating the one or more measurements or an availability of the one or more measurements; means for selecting, based at least on the one or more reports, at least one user equipment from the at least subset of the one or more candidate user equipments; means for receiving, from the at least one user equipment, positioning-related data that is complementary to one or more positioning data samples received from the first user equipment; and means for combining the positioning-related data received from the at least one user equipment with the one or more positioning data samples received from the first user equipment.

According to another aspect, there is provided a method comprising: transmitting, to one or more candidate user equipments, a request for reporting one or more measurements suitable for evaluating similarity of propagation conditions of the one or more candidate user equipments and a first user equipment; receiving, from at least a subset of the one or more candidate user equipments, one or more reports indicating the one or more measurements or an availability of the one or more measurements; selecting, based at least on the one or more reports, at least one user equipment from the at least subset of the one or more candidate user equipments; receiving, from the at least one user equipment, positioning-related data that is complementary to one or more positioning data samples received from the first user equipment; and combining the positioning-related data received from the at least one user equipment with the one or more positioning data samples received from the first user equipment.

According to another aspect, there is provided a computer program comprising instructions which, when executed by an apparatus, cause the apparatus to perform at least the following: transmitting, to one or more candidate user equipments, a request for reporting one or more measurements suitable for evaluating similarity of propagation conditions of the one or more candidate user equipments and a first user equipment; receiving, from at least a subset of the one or more candidate user equipments, one or more reports indicating the one or more measurements or an availability of the one or more measurements; selecting, based at least on the one or more reports, at least one user equipment from the at least subset of the one or more candidate user equipments; receiving, from the at least one user equipment, positioning-related data that is complementary to one or more positioning data samples received from the first user equipment; and combining the positioning-related data received from the at least one user equipment with the one or more positioning data samples received from the first user equipment.

According to another aspect, there is provided a computer readable medium comprising program instructions which, when executed by an apparatus, cause the apparatus to perform at least the following: transmitting, to one or more candidate user equipments, a request for reporting one or more measurements suitable for evaluating similarity of propagation conditions of the one or more candidate user equipments and a first user equipment; receiving, from at least a subset of the one or more candidate user equipments, one or more reports indicating the one or more measurements or an availability of the one or more measurements; selecting, based at least on the one or more reports, at least one user equipment from the at least subset of the one or more candidate user equipments; receiving, from the at least one user equipment, positioning-related data that is complementary to one or more positioning data samples received from the first user equipment; and combining the positioning-related data received from the at least one user equipment with the one or more positioning data samples received from the first user equipment.

According to another aspect, there is provided a non-transitory computer readable medium comprising program instructions which, when executed by an apparatus, cause the apparatus to perform at least the following: transmitting, to one or more candidate user equipments, a request for reporting one or more measurements suitable for evaluating similarity of propagation conditions of the one or more candidate user equipments and a first user equipment; receiving, from at least a subset of the one or more candidate user equipments, one or more reports indicating the one or more measurements or an availability of the one or more measurements; selecting, based at least on the one or more reports, at least one user equipment from the at least subset of the one or more candidate user equipments; receiving, from the at least one user equipment, positioning-related data that is complementary to one or more positioning data samples received from the first user equipment; and combining the positioning-related data received from the at least one user equipment with the one or more positioning data samples received from the first user equipment.

According to another aspect, there is provided an apparatus comprising at least one processor, and at least one memory storing instructions that, when executed by the at least one processor, cause the apparatus at least to: receive, from a network entity, a request for reporting one or more measurements suitable for evaluating similarity of propagation conditions of the apparatus and a first user equipment; transmit, to the network entity, a report indicating the one or more measurements or an availability of the one or more measurements; and transmit, to the network entity, positioning-related data to be combined with one or more positioning data samples provided from the first user equipment, the positioning-related data being complementary to the one or more positioning data samples provided from the first user equipment.

According to another aspect, there is provided an apparatus comprising: means for receiving, from a network entity, a request for reporting one or more measurements suitable for evaluating similarity of propagation conditions of the apparatus and a first user equipment; means for transmitting, to the network entity, a report indicating the one or more measurements or an availability of the one or more measurements; and means for transmitting, to the network entity, positioning-related data to be combined with one or more positioning data samples provided from the first user equipment, the positioning-related data being complementary to the one or more positioning data samples provided from the first user equipment.

According to another aspect, there is provided a method comprising: receiving, by an apparatus, from a network entity, a request for reporting one or more measurements suitable for evaluating similarity of propagation conditions of the apparatus and a first user equipment; transmitting, by the apparatus, to the network entity, a report indicating the one or more measurements or an availability of the one or more measurements; and transmitting, by the apparatus, to the network entity, positioning-related data to be combined with one or more positioning data samples provided from the first user equipment, the positioning-related data being complementary to the one or more positioning data samples provided from the first user equipment.

According to another aspect, there is provided a computer program comprising instructions which, when executed by an apparatus, cause the apparatus to perform at least the following: receiving, from a network entity, a request for reporting one or more measurements suitable for evaluating similarity of propagation conditions of the apparatus and a first user equipment; transmitting, to the network entity, a report indicating the one or more measurements or an availability of the one or more measurements; and transmitting, to the network entity, positioning-related data to be combined with one or more positioning data samples provided from the first user equipment, the positioning-related data being complementary to the one or more positioning data samples provided from the first user equipment.

According to another aspect, there is provided a computer readable medium comprising program instructions which, when executed by an apparatus, cause the apparatus to perform at least the following: receiving, from a network entity, a request for reporting one or more measurements suitable for evaluating similarity of propagation conditions of the apparatus and a first user equipment; transmitting, to the network entity, a report indicating the one or more measurements or an availability of the one or more measurements; and transmitting, to the network entity, positioning-related data to be combined with one or more positioning data samples provided from the first user equipment, the positioning-related data being complementary to the one or more positioning data samples provided from the first user equipment.

According to another aspect, there is provided a non-transitory computer readable medium comprising program instructions which, when executed by an apparatus, cause the apparatus to perform at least the following: receiving, from a network entity, a request for reporting one or more measurements suitable for evaluating similarity of propagation conditions of the apparatus and a first user equipment; transmitting, to the network entity, a report indicating the one or more measurements or an availability of the one or more measurements; and transmitting, to the network entity, positioning-related data to be combined with one or more positioning data samples provided from the first user equipment, the positioning-related data being complementary to the one or more positioning data samples provided from the first user equipment.

### BRIEF DESCRIPTION OF THE DRAWINGS

In the following, various example embodiments will be described in greater detail with reference to the accompanying drawings, in which

FIG. 1A illustrates an example of a wireless communication network;

FIG. 1B illustrates an example of a system;

FIG. 2 illustrates a signal flow diagram;

FIG. 3 illustrates a flow chart;

FIG. 4 illustrates a flow chart;

FIG. 5 illustrates a flow chart;

FIG. 6 illustrates a flow chart;

FIG. 7 illustrates an example of an apparatus; and

FIG. 8 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Some example embodiments described herein may be implemented in a wireless communication network comprising a radio access network based on one or more of the following radio access technologies: Global System for Mobile Communications (GSM) or any other second generation radio access technology, Universal Mobile Telecommunication System (UMTS, 3G) based on basic wideband-code division multiple access (W-CDMA), high-speed packet access (HSPA), Long Term Evolution (LTE), LTE-Advanced, fourth generation (4G), fifth generation (5G), 5G new radio (NR), 5G-Advanced (i.e., 3GPP NR Rel-18 and beyond), or sixth generation (6G). Some examples of radio access networks include the universal mobile telecommunications system (UMTS) radio access network (UTRAN), the Evolved Universal Terrestrial Radio Access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications.

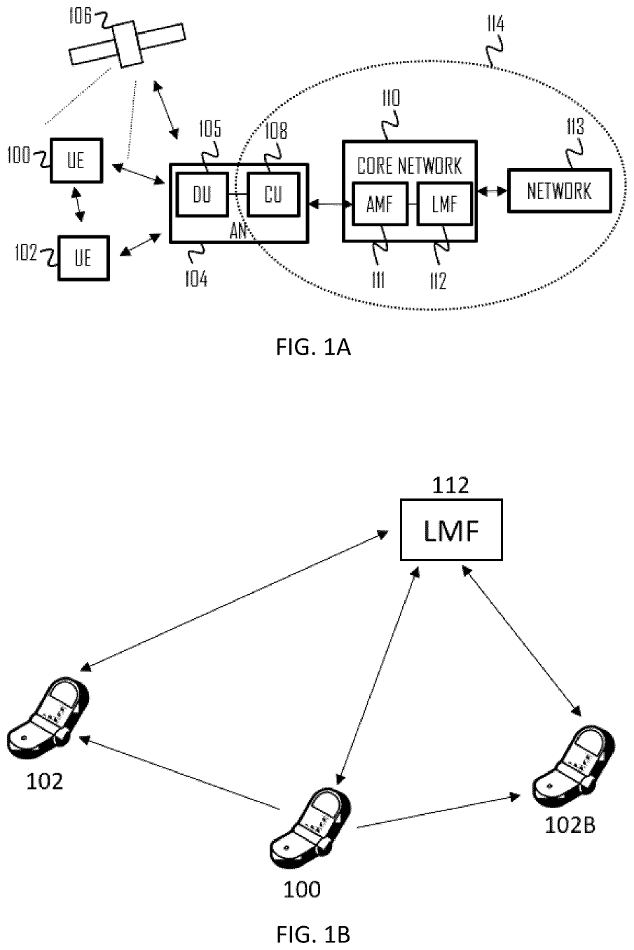

FIG. 1A depicts an example of a simplified wireless communication network showing some physical and logical entities. The connections shown in FIG. 1A may be physical connections or logical connections. It is apparent to a person skilled in the art that the wireless communication network may also comprise other physical and logical entities than those shown in FIG. 1A.

The example embodiments described herein are not, however, restricted to the wireless communication network given as an example but a person skilled in the art may apply the embodiments described herein to other wireless communication networks provided with necessary properties.

The example wireless communication network shown in FIG. 1A includes an access network, such as a radio access network (RAN), and a core network 110.

FIG. 1A shows user equipment (UE) 100, 102 configured to be in a wireless connection on one or more communication channels in a radio cell with an access node (AN) 104 of an access network. The AN 104 may be an evolved Node B (abbreviated as eNB or eNodeB) or a next generation Node B (abbreviated as gNB or gNodeB), providing the radio cell. The wireless connection (e.g., radio link) from a UE to the access node 104 may be called uplink (UL) or reverse link, and the wireless connection (e.g., radio link) from the access node to the UE may be called downlink (DL) or forward link. UE 100 may also communicate directly with UE 102, and vice versa, via a wireless connection generally referred to as a sidelink (SL). It should be appreciated that the access node 104 or its functionalities may be implemented by using any node, host, server or access point etc. entity suitable for providing such functionalities.

The access network may comprise more than one access node, in which case the access nodes may also be configured to communicate with one another over links, wired or wireless. These links between access nodes may be used for sending and receiving control plane signaling and also for routing data from one access node to another access node.

The access node may comprise a computing device configured to control the radio resources of the access node. The access node may also be referred to as a base station, a base transceiver station (BTS), an access point, a cell site, a radio access node or any other type of node capable of being in a wireless connection with a UE (e.g., UEs 100, 102). The access node may include or be coupled to transceivers. From the transceivers of the access node, a connection may be provided to an antenna unit that establishes bi-directional radio links to UEs 100, 102. The antenna unit may comprise an antenna or antenna element, or a plurality of antennas or antenna elements.

The access node 104 may further be connected to a core network (CN) 110. The core network 110 may comprise an evolved packet core (EPC) network and/or a 5^{th} generation core network (5GC). The EPC may comprise network entities, such as a serving gateway (S-GW for routing and forwarding data packets), a packet data network gateway (P-GW) for providing connectivity of UEs to external packet data networks, and a mobility management entity (MME). The 5GC may comprise network functions, such as a user plane function (UPF), an access and mobility management function (AMF) 111, and a location management function (LMF) 112.

With respect to positioning, the core network 110 may comprise a 5GC having a service-based architecture. The 5GC may comprise various network functions, including an AMF 111 and a location management function (LMF) 112. The AMF 111 may be configured to provide location information for call processing, mobility policy enforcement, and charging purposes to other network functions in the core network 110 and to other entities requesting for positioning of UEs. The AMF 111 may receive and manage location requests from several entities: mobile-originated location requests (MO-LR) received from the UEs 100, 102 and mobile-terminated location requests (MT-LR) destined for other functions of the core network or the access network. The AMF 111 may select the LMF 112 for a given request and use its positioning service to trigger a positioning session. The LMF 112 may then carry out the positioning upon receiving such a request from the AMF 111. The LMF 112 may manage the resources and timing of positioning activities. The LMF 112 may obtain location information for a UE 100, 102 with at least one of the following ways: by sending a Namf_Communication service request via the NL1 interface to one or more access nodes for network-based positioning; or by communicating with the UE 100, 102 over the N1 interface for UE-based or UE-assisted positioning. The location information obtained by the LMF 112 may include an estimation of the location of the UE and, additionally, the LMF 112 may also estimate movement or accuracy of the location information when requested. Connection-wise, the AMF 111 may be between the access node 104 and the LMF 112 and, thus, closer to the access nodes 104 than the LMF 112.

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or any computing device comprising a wireless modem integrated in a vehicle.

It should be appreciated that a UE may also be a nearly exclusive uplink-only device, of which an example may be a camera or video camera loading images or video clips to a network. A UE may also be a device having capability to operate in an Internet of Things (IoT) network, which is a scenario in which objects may be provided with the ability to transfer data over a network without requiring human-to-human or human-to-computer interaction. The UE may also utilize cloud. In some applications, the computation may be carried out in the cloud or in another UE.

The wireless communication network may also be able to support the usage of cloud services, for example at least part of core network operations may be carried out as a cloud service (this is depicted in FIG. 1A by “cloud” 114). The wireless communication network may also comprise a central control entity, or the like, providing facilities for wireless communication networks of different operators to cooperate for example in spectrum sharing. 5G enables using multiple input-multiple output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications, such as (massive) machine-type communications (mMTC), including vehicular safety, different sensors and real-time control.

In 5G wireless communication networks, access nodes and/or UEs may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHz-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

In some example embodiments, an access node (e.g., access node 104) may comprise: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node. The DU 105 may be a logical node hosting radio link control (RLC), medium access control (MAC) and/or physical (PHY) layers of the NR protocol stack for the access node. The operations of the DU may be at least partly controlled by the CU. It should also be understood that the distribution of functions between DU 105 and CU 108 may vary depending on implementation. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU 105) and non-real-time functions being carried out in a centralized manner (e.g., in a CU 108).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). A given satellite 106 in the mega-constellation may cover several satellite-enabled network entities that create on-ground cells. The on-ground cells may be created through an on-ground relay access node or by an access node 104 located on-ground or in a satellite.

It is obvious for a person skilled in the art that the access node 104 depicted in FIG. 1A is just an example of a part of an access network (e.g., a radio access network) and in practice, the access network may comprise a plurality of access nodes, the UEs 100, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1A may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of access networks, the concept of “plug-and-play” access nodes may be introduced. An access network which may be able to use “plug-and-play” access nodes, may include, in addition to Home eNodeBs or Home gNodeBs, a Home Node B gateway, or HNB-GW (not shown in FIG. 1A). An HNB-GW, which may be installed within an operator's access network, may aggregate traffic from a large number of Home eNodeBs or Home gNodeBs back to a core network of the operator.

Positioning is a process that may be used to estimate a position (e.g., a geographic location) of a UE 100, 102. Herein the UE to be positioned is referred to as a target UE. For example, the positioning techniques used in 5G NR may be based on at least one of the following: time difference of arrival (TDoA), time of arrival (TOA), time of departure (TOD), round trip time (RTT), angle of departure (AoD), angle of arrival (AoA), and/or carrier phase.

The position of the target UE may be estimated in an absolute manner (in case of absolute positioning) or in a relative manner (in case of relative positioning).

Absolute positioning refers to estimating the position of the target UE in two-dimensional or three-dimensional geographic coordinates (e.g., latitude, longitude, and/or elevation) within a coordinate system.

Relative positioning refers to estimating the position of the target UE relative to one or more network nodes or relative to one or more other UEs.

In Uu positioning (UL and/or DL positioning), multiple transmission and reception points (TRPs) in known locations may transmit one or more positioning reference signals (PRS) to the target UE, and/or receive and measure one or more positioning reference signals from the target UE. In the uplink, a sounding reference signal (SRS) may be used as a positioning reference signal. For example, multilateration techniques may then be used to localize (i.e., position) the target UE with respect to the TRPs. At least one TRP out of these TRPs may be used as a positioning anchor, and the differences in TDoA may be computed with respect to this positioning anchor. The positioning anchor may also be referred to as an anchor, anchor node, multilateration anchor, or reference point.

In network-based positioning, the position of the target UE is determined or calculated by a network entity (e.g., gNB or LMF). For network-based positioning, the target UE may report information to the network entity to enable determining the position of the target UE.

In UE-based positioning, the position of the target UE is determined or calculated by the target UE or another UE.

Sidelink (SL) positioning refers to the positioning approach, where the target UE utilizes the sidelink (i.e., the direct device-to-device link) to position itself, either in an absolute manner (in case of absolute positioning) or in a relative manner (in case of relative positioning). SL positioning may be beneficial in, for example (but not limited to), the following use cases: public safety, vehicle-to-everything (V2X), and industrial internet of things (IIoT).

SL positioning may be based on the transmission of a sidelink positioning reference signal (SL-PRS) by multiple anchor UEs (e.g., at least three anchor UEs), wherein the SL-PRS is received and measured by a target UE to enable localization of the target UE (e.g., using SL TDoA techniques) within certain latency and accuracy requirements of the corresponding SL positioning session. Alternatively, or additionally, the target UE may transmit SL-PRS to be received and measured by the anchor UEs. The exchange of SL-PRS between the target UE and anchor UEs may be used, for example, in SL RTT based positioning techniques.

Furthermore, positioning reference units (PRUs) may be used in the positioning session for increasing the positioning accuracy for positioning the target UE. PRUs are reference devices at known locations, which are taking measurements that are used to generate correction data that may be used to refine the location estimate of a target UE in the area, thereby increasing the positioning accuracy for positioning the target UE. For example, a UE with a known location may be used as a PRU.

In other words, PRUs located at known locations may act as reference target UEs, such that their calculated position may be compared with their known location. The comparison of the known and estimated location may result in correction data, which can be used for the location estimation process of other target UEs in the vicinity, under the assumption that the same or similar accuracy determination effects apply to both the location of the PRU and the location of the other target UEs. Then, the correction data may be used for fine-tuning the location estimate of the target UEs, thereby increasing the positioning accuracy.

Artificial intelligence (AI) or machine learning (ML) models may be used for enhancing UE positioning. In AI or ML positioning, the AI or ML model may be trained and/or adapted or updated or fine-tuned using training data samples collected from UEs in the field. Also, as a continuous task, the AI or ML model may be monitored to evaluate its performance in the field. To make these tasks possible, it may be required to collect training or evaluation data samples (e.g., positioning data samples) in the deployed environment.

Such a training or evaluation data sample (positioning data sample) may comprise a set of input features associated with a label. The set of input features may comprise, for example, at least one of: the strongest channel tap gains and their delays, the power delay profile of the radio channel, the received signal samples, etc.

The associated label may comprise, for example, at least one of: UE location (e.g., two-dimensional or three-dimensional location), line-of-sight indicator, time of arrival (TOA), angle of departure (AoD), etc.

A UE selected by the network may be required to provide complete training data samples for a given period of time, and with a given collection speed, i.e., to collect all the input features and label them with an appropriate label. However, in practice, this requirement may be difficult to achieve for the UE for the following reasons:
The UE may experience interference or be in bad noise conditions, in which case the input features may be poorly extracted, or missing either partly or completely.
The UE capability may affect the quality of data gathered from the mentioned input features.
The positioning signals may not have sufficient resolution or bandwidth for the UE to extract sufficiently accurate input features.
The UE may not have the means to label each input feature with the corresponding label, for example because the label computation may be delayed. For example, if the label is provided by the global navigation satellite system (GNSS) receiver, the receiver may not be synchronized with the feature extraction, and therefore the timestamp of the GNSS-sourced label may not match the timestamp of the feature extraction. Alternatively, or additionally, the label may be inaccurate or be missing altogether. For example, for some training data samples, the UE may not be able to obtain its own location estimate (e.g., GNSS accuracy may be low indoors, or the location estimate may be poor in non-line-of-sight conditions, etc.).

In the above situations, the UE may only be able to provide partial training data, i.e., a training data set where some of the data samples are unreliable or incomplete (e.g., due to incompleteness of input features and/or labels). Nevertheless, the training data samples, despite being incomplete, may still be valuable for the model training or updating or fine-tuning or monitoring, and thus the incomplete training data samples should not be discarded. Discarding the incomplete data samples may make the training data set scarce, imbalanced, and possibly yield models that do not generalize well. However, replacing the current UE by another peer UE may not be a desirable solution either, since there is no guarantee that the peer UE will not end up collecting incomplete training data samples as well.

Therefore, to enable the model training and adaptation using training data samples obtained from a UE in the field, it is desirable to provide solutions that cope with incomplete training data samples.

Some example embodiments may provide a method for collecting positioning training data that overcomes the problem of incomplete training data sample reporting. In some example embodiments, a target UE may be triggered to collect and report field data samples, but the UE is allowed to report incomplete data samples, if the UE is not capable of generating a complete data sample.

For example, if the data sample is a training data sample, then the data sample may be deemed as incomplete when at least one of the (expected) input features and/or at least one of the (expected) labels is missing.

If the data sample is not a training data sample, then the data sample may be deemed as incomplete when at least one of the (expected) input features is missing.

As an example, the UE may be requested to report N data samples, where a given data sample comprises an input feature set (e.g., reference signal received power and delay per path for a plurality of paths) and a label (e.g., the UE location in X, Y or X, Y, Z coordinates). In this case, the incomplete data sample may mean that some of these expected entries (features and/or labels) are missing from the data sample. Herein the term “path” refers to a signal propagation path from the UE and a network node.

For example, the incomplete data sample may comprise the reference signal received power (RSRP) and delay for a subset of the plurality of paths, but the RSRP and delay for some of the paths may be missing from the data sample. Alternatively, or additionally, the label or a part of the label may be missing from the incomplete data sample. For example, the label may only include the X coordinate, but not the Y or Z coordinates.

Some example embodiments are described below using principles and terminology of 5G radio access technology without limiting the example embodiments to 5G radio access technology, however.

FIG. 1B illustrates an example of a system, to which some example embodiments may be applied. FIG. 1B may be understood to depict a part of the wireless communication network of FIG. 1A. In this example, the system comprises a target UE 100, one or more candidate donor UEs 102, 102B, and a location management entity such as an LMF 112. Herein the term “donor UE” refers to an UE that can provide the missing entries in the incomplete data sample provided by the target UE 100.

In an example embodiment, the following steps may be performed in order to cope with the incomplete data sample of the target UE 100: finding at least one candidate donor UE 102, 102B that can provide some or all of the missing entries in the incomplete data sample provided by the target UE 100; testing the at least one candidate donor UE 102, 102B for donor fitness relative to the target UE 100; activating the at least one candidate donor UE 102, 102B for the data sample donor role; and combining data from the at least one donor UE 102, 102B and the target UE 100 in order to fill in the missing entries in the incomplete data sample of the target UE 100.

For example, the fitness test of the at least one candidate donor UE 102, 102B may mean that the at least one candidate donor UE 102, 102B measures one or more signals related to the target UE 100, such as a demodulation reference signal (DMRS), SL-PRS or SRS transmitted from the target UE 100.

As an example, the measurements may include at least one of: cross link interference (CLI) reference signal received power (RSRP) of the target UE 100, CLI reference signal strength indicator (RSSI) of the target UE 100, and/or one or more sidelink measurements associated with the target UE 100.

If there is a sidelink connection between the at least one candidate donor UE 102, 102B and the target UE 100, then the at least one candidate donor UE 102, 102B may measure SL-PRS or any other sidelink reference signal transmitted from the target UE 100. If there is no sidelink connection, then the network (e.g., serving gNB or LMF) may configure the at least one candidate donor UE 102, 102B for CLI measurements and indicate which resources to measure and what to measure on those resources. The network (e.g., the serving gNB or LMF) may provide the at least one candidate donor UE 102, 102B with the information that the at least one candidate donor UE 102, 102B needs to decode the reference signal on those resources and measure, for example, reference signal received power (RSRP) of the reference signal.

The at least one candidate donor UE 102 may then report these measurements to the LMF 112, so that the LMF 112 can evaluate, for example, their proximity to each other, and to subsequently choose an appropriate donor UE.

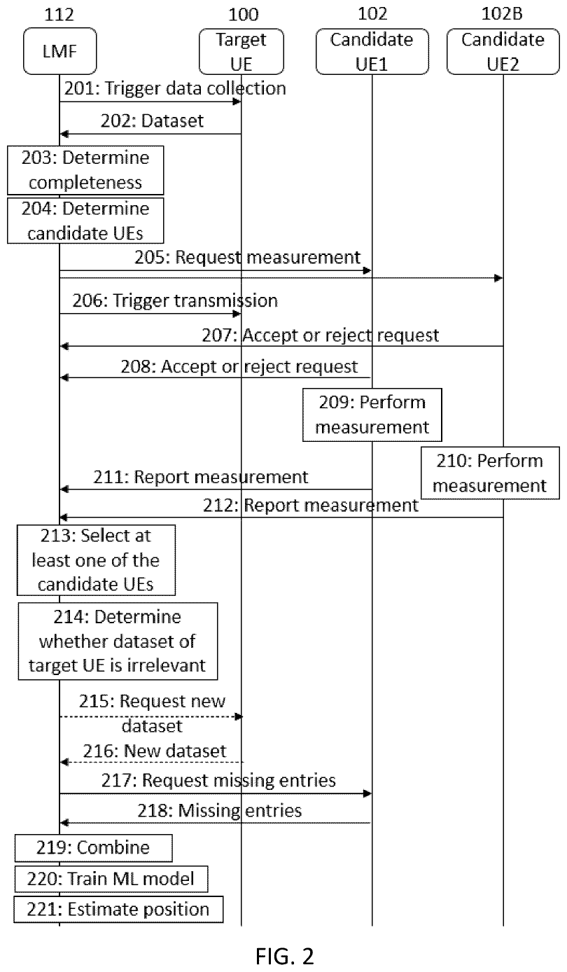

FIG. 2 illustrates a signal flow diagram according to an example embodiment. Although two candidate UEs (candidate UE1 and candidate UE2) are shown in FIG. 2, it should be noted that the number of candidate UEs may also be different than two. In other words, there may be one or more candidate UEs. In addition, the signaling procedure illustrated in FIG. 2 may be extended and applied according to the actual number of candidate UEs.
At 201, a network entity such as an LMF 112 transmits, to a target UE 100, an indication for triggering data collection at the target UE 100. For example, the data collection may be for training or updating or monitoring a machine learning model. The target UE 100 may also be referred to as a first user equipment herein. Although the LMF 112 is used as an example in FIG. 2, it should be noted that the network entity may alternatively be, for example, another type of location server, or a location management component (LMC), or a radio access network node such as a gNB, or a user equipment.
At 202, the LMF 112 receives a dataset from the target UE 100 in response to triggering the data collection.
At 203, the LMF 112 determines the completeness of the dataset by determining whether one or more positioning data samples in the dataset are incomplete. For example, the LMF 112 may determine whether the portion of complete positioning data samples in the dataset is below a threshold. The completeness of the dataset may be determined during data cleaning, wherein missing values may be identified and an imbalance analysis may be performed.

The one or more positioning data samples may be determined as incomplete, for example, by determining that at least one of the following is unreliable or missing in the one or more positioning data samples: at least one expected input feature, or at least one expected label. Some examples of the input features and labels are described above.
At 204, based on determining that the one or more positioning data samples are incomplete (e.g., if the portion of complete positioning data samples is below the threshold), the LMF 112 determines one or more candidate user equipments 102, 102B (candidate donor UEs) for providing the one or more entries (e.g., input features or labels) deemed to be unreliable or missing in the one or more positioning data samples determined to be incomplete. The one or more candidate user equipments 102, 102B may comprise, for example, one or more UEs nearby the target UE 100 and/or one or more positioning reference units (PRUs).

For example, the one or more candidate user equipments may be determined based on at least one of: a similarity of a statistic distribution of the dataset of the target UE and a dataset of the one or more candidate user equipments (i.e., similar dataset statistic distribution on available features and/or from past sessions), a range (distance) between the target UE and the one or more candidate user equipments (e.g., based on past sidelink communication between the UEs), or a common serving beam associated with the target UE and the one or more candidate user equipments.
At 205, the LMF 112 transmits, to the one or more candidate user equipments (e.g., the first candidate UE 102 and the second candidate UE 102B), a request (or trigger) for performing one or more measurements suitable for evaluating similarity of propagation conditions of the one or more candidate user equipments 102, 102B and the target UE 100.

The propagation conditions of a UE refer to the characteristics of the radio environment and the signal transmission between the UE and a network node (e.g., gNB in a 5G NR network) or another UE, as the radio waves travel through the air. These conditions may affect the quality and performance of the wireless communication link.

For example, the propagation conditions may depend on the distance between the UE and the network node or other UE. The signal strength decreases as the distance increases, leading to higher path loss. Thus, proximity of the one or more candidate user equipments 102, 102B to the target UE 100 is one way to determine the similarity of the propagation conditions. In other words, UEs that are close to each other may experience similar propagation conditions.

As another example, the propagation conditions may depend on the terrain and environment. The presence of buildings, trees, hills, and other obstacles may cause signal reflections, diffraction, and scattering, leading to multipath propagation, fading, and shadowing effects. For example, UEs on an empty field may experience similar propagation conditions (e.g., both in line-of-sight conditions) without necessarily being close to each other.

In other words, the LMF requests the one or more candidate user equipments to perform the donor fitness test described above. The one or more candidate user equipments receive the request.

The fitness test, as the name suggests, is done in order to select the best UE(s), which can act as a donor for the target UE. In other words, the fitness test may be initiated by the LMF in order to down-select a sufficient number of donors to complete the missing entries in the incomplete positioning sample(s) provided by the target UE. The fitness test request (or trigger message) may be implemented, for example, as a set of information elements in the “LPP ProvideAssistanceData” message. LPP is an abbreviation for LTE positioning protocol.

The request (or trigger message) may indicate at least one of: an indicator (e.g., a binary flag) indicating to perform the one or more measurements, a type of the one or more measurements (e.g., CLI RSRP and/or CLI RSSI), and one or more radio resources on which the one or more measurements are to be performed. For example, the one or more radio resources may be indicated as a demodulation reference signal (DMRS) pattern of the target UE 100.
At 206, if the target UE 100 does not have an ongoing transmission, the LMF 112 may transmit an indication to the target UE 100 for triggering the target UE 100 to transmit a reference signal configured by the network (e.g., the serving gNB of the target UE), so that the one or more measurements can be collected. The target UE 100 may start transmitting the reference signal based on receiving the indication.
At 207, the first candidate UE 102 determines whether to accept the request and transmits, to the LMF 112, based on the determination, a response indicating an acceptance or a rejection to the request for providing the one or more measurements. Thus, the first candidate UE implicitly accepts or rejects acting as a donor for the target UE. In this example, the first candidate UE may determine to accept the request, in which case the response indicates an acceptance to the request.

This response message may be carried, for example, by an LPP reply. The response message may comprise at least one of: an acknowledgement (ACK) or a negative acknowledgement (NACK) to the request, and/or the time duration during which the one or more measurements can be provided (i.e., the duration for which the UE may accept to become a donor).
At 208, the second candidate UE 102B determines whether to accept the request and transmits, to the LMF 112, based on the determination, a response indicating an acceptance or a rejection to the request for providing the one or more measurements. Thus, the second candidate UE implicitly accepts or rejects acting as a donor for the target UE. In this example, the second candidate UE may determine to accept the request, in which case the response indicates an acceptance to the request.

This response message may be carried, for example, by an LPP reply. The response message may comprise at least one of: an acknowledgement (ACK) or a negative acknowledgement (NACK) to the request, and/or the time duration during which the one or more measurements can be provided (i.e., the duration for which the UE may accept to become a donor).
At 209, the first candidate UE 102 may perform or obtain the one or more measurements (if it accepted the request). Alternatively, the first candidate UE 102 may skip performing the one or more measurements, if it has previously already obtained the one or more measurements as part of a different process. For example, the one or more measurements may comprise one or more cross link interference measurements (e.g., CLI RSRP and/or CLI RSSI) or one or more sidelink measurements associated with the target UE 100 by the first candidate UE 102.

For example, the first candidate UE 102 may perform the one or more sidelink measurements by measuring a sidelink positioning reference signal (SL-PRS) or any other sidelink reference signal transmitted from the target UE 100. Alternatively, the first candidate UE 102 may perform the one or more cross link interference measurements by measuring a reference signal (e.g., DMRS or any other reference signal) transmitted from the target UE 100.
At 210, the second candidate UE 102B may perform or obtain the one or more measurements (if it accepted the request). Alternatively, the second candidate UE 102B may skip performing the one or more measurements, if it has already obtained the one or more measurements as part of a different process. For example, the one or more measurements may comprise one or more cross link interference measurements (e.g., CLI RSRP and/or CLI RSSI) or one or more sidelink measurements associated with the target UE 100 by the second candidate UE 102B.
At 211, the first candidate UE 102 transmits, to the LMF 112, a report indicating the one or more measurements or an availability of the one or more measurements performed at the first candidate UE. The LMF receives the report.

For example, the first candidate UE 102 may estimate the range (distance) between the first candidate UE 102 and the target UE 100 based on the one or more measurements, in which case the first candidate UE 102 may report the estimated range (distance) to the LMF 112. Alternatively, the first candidate UE 102 may report the one or more measurements to the LMF 112, so that the LMF 112 can estimate the range (distance) between the first candidate UE 102 and the target UE 100.
At 212, the second candidate UE 102B transmits, to the LMF 112, a report indicating the one or more measurements or an availability of the one or more measurements performed at the second candidate UE. The LMF receives the report.
At 213, the LMF 112 selects, based at least on the reports, at least one user equipment from the candidate user equipments 102, 102B. The selection may also be based on serving gNB information such as serving beam, etc. In other words, the LMF may select at least one UE that it deems to be the best donor(s), for example, in the neighborhood of the target UE 100.

The neighborhood size may be defined, for example, in relation to a given CLI RSRP threshold. In this case, the at least one user equipment may be selected based on a CLI RSRP measurement reported from the at least one user equipment being above a threshold. In other words, some or all candidate UEs reporting a CLI RSRP greater than the threshold may be selected as donors. However, it should be noted that other selection criteria may be applied as well.
At 214, the LMF 112 may determine whether the dataset received from the target UE at 202 is irrelevant. Herein irrelevant may mean, for example, that the dataset is too old or too noisy.
At 215, if the LMF 112 determines that the dataset received from the target UE is irrelevant, the LMF may transmit, to the target UE 100, an indication to provide a new dataset.
At 216, if the LMF 112 transmitted the indication to provide the new dataset, the LMF 112 may receive the new dataset from the target UE 100.
At 217, the LMF 112 transmits, to the selected at least one user equipment (e.g., the first candidate UE 102 selected as donor), an indication or request for providing the one or more entries deemed to be unreliable or missing in the one or more positioning data samples received from the target UE at 202 or 216. In other words, the LMF triggers or activates the donor UE(s) to collect the entries deemed as missing or unreliable in the most recent dataset reported from the target UE. The at least one selected user equipment receives the indication or request.

This indication or request may be implemented, for example, as a set of new information elements in the “LPP RequestLocationInformation” message. This indication or the request may indicate, for example, at least one of: a time window during which the one or more entries should be provided (i.e., the duration for which the donor role is active), and a list of the one or more entries to be provided.

The time window may be expressed, for example, as a start time (e.g., in subframe numbers) with respect to the reception of this message and a total duration (e.g., also in subframe numbers).

For example, if a positioning data sample in the most recent dataset reported from the target UE is missing input features A and B, and label X, then the selected donor(s) may be requested to measure and report input features A and B, and label X.

As a more specific example, if a positioning data sample in the most recent dataset reported from the target UE is missing angle of departure (AoD) for one or more TRPs, then the selected donor(s) may be requested to measure, timestamp, and report at least the AoD for the one or more TRPs. Herein the AoD is an example of a missing label.
At 218, based on the indication or request received at 216, the selected at least one user equipment (e.g., the first candidate UE 102) transmits, to the LMF 112, positioning-related data that is complementary to the one or more positioning data samples received from the target UE at 202 or 216. The LMF receives the positioning-related data from the selected at least one user equipment.

The positioning-related data being complementary may mean that the positioning-related data received from the at least one user equipment comprises some or all of the one or more entries deemed to be unreliable or missing in the one or more positioning data samples received from the target UE at 202 or 216.

The one or more entries may comprise at least one of: the at least one expected input feature or the at least one expected label determined to be unreliable or missing in the one or more positioning data samples received from the target UE.
At 219, the LMF 112 combines the positioning-related data received from the selected at least one user equipment 102 with the one or more positioning data samples received from the target UE 100 at 202 or 216. In other words, the LMF collects data from the selected donor(s) and combines it with the training data samples received from the target UE according to a selected strategy.

In case the LMF determined that the dataset received at 202 is irrelevant (e.g., too old or too noisy), then the positioning-related data received from the selected at least one user equipment may be combined with the one or more positioning data samples in the new dataset received from the target UE at 216.

In case the LMF determined that the dataset received at 202 is not irrelevant, then the positioning-related data received from the selected at least one user equipment may be combined with the one or more positioning data samples in the dataset received from the target UE at 202.
At 220, the LMF 112 may provide the one or more positioning data samples combined with the positioning-related data received from the selected at least one user equipment as training data for training or updating the machine learning model for positioning.
At 221, the LMF 112 may estimate a position of the target UE 100 or one or more other user equipments by using the trained machine learning model. For example, the machine learning model may be area specific, such that any UE that arrives in the same area may be positioned with the machine learning model derived from the one or more positioning data samples of the target UE.

Herein the terms ‘first user equipment’, ‘first candidate UE’ and ‘second candidate UE’ are used to distinguish the UEs, and they do not necessarily mean a specific order or specific identifiers of the UEs.

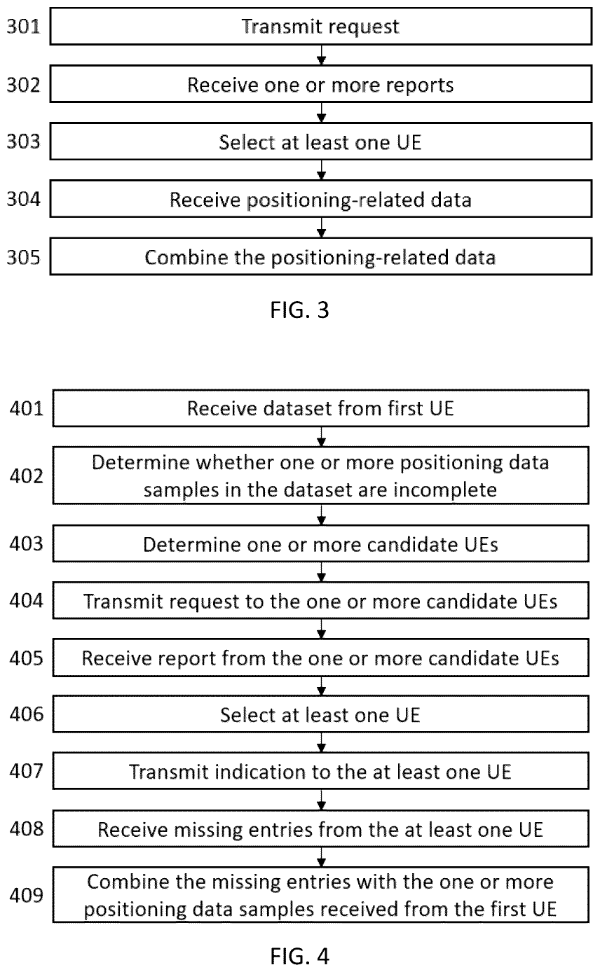

FIG. 3 illustrates a flow chart according to an example embodiment of a method performed by an apparatus 800. For example, the apparatus 800 may a comprise a location management entity, such as a location management function 112 or location server, or another network entity such as a radio access network node (e.g., gNB) or a user equipment.

Referring to FIG. 3, in block 301, the apparatus transmits, to one or more candidate user equipments 102, 102B, a request for reporting one or more measurements suitable for evaluating similarity of propagation conditions of the one or more candidate user equipments 102, 102B and a first user equipment 100.

For example, proximity of the one or more candidate user equipments 102, 102B to the target UE 100 is one way to determine the similarity of the propagation conditions. The proximity may be evaluated at the apparatus or at the or more candidate user equipments 102, 102B.

The request may indicate at least: a type of the one or more measurements, and one or more radio resources on which the one or more measurements are to be performed. For example, the one or more measurements may comprise one or more cross link interference measurements or one or more sidelink measurements associated with the first equipment.

The apparatus may receive, from the one or more candidate user equipments, a response indicating an acceptance or a rejection to the request for providing the one or more measurements. The response may further indicate a time duration during which the one or more measurements can be provided.

In block 302, the apparatus receives, from at least a subset of the one or more candidate user equipments 102, 102B (e.g., from the candidate UE(s) that accepted the request), one or more reports indicating the one or more measurements or an availability of the one or more measurements.

In block 303, the apparatus selects, based at least on the one or more reports, at least one user equipment 102 from the at least subset of the one or more candidate user equipments 102, 102B.

For example, the at least one user equipment may be selected by evaluating proximity of the at least subset of the one or more candidate user equipments to the first user equipment based on the one or more reports, the proximity being indicative of the similarity of the propagation conditions. In other words, the selected at least one user equipment may be close to the first user equipment (e.g., within a pre-defined distance from the first user equipment).

In block 304, the apparatus receives, from the at least one user equipment 102, positioning-related data that is complementary to one or more positioning data samples received from the first user equipment 100.

For example, the positioning-related data received from the at least one user equipment may comprise one or more entries deemed to be unreliable or missing in the one or more positioning data samples received from the first user equipment.

In block 305, the apparatus combines the positioning-related data received from the at least one user equipment 102 with the one or more positioning data samples received from the first user equipment 100.

The apparatus may provide the one or more positioning data samples combined with the positioning-related data received from the at least one user equipment as training data for training a machine learning model for positioning; and estimate a position of the first user equipment or one or more other user equipments by using the trained machine learning model.

The apparatus may determine whether a dataset received from the first user equipment is irrelevant. Based on determining that the dataset received from the first user equipment is irrelevant, the apparatus may transmit, to the first user equipment, an indication to provide a new dataset; and receive the new dataset from the first user equipment. In this case, the positioning-related data received from the at least one user equipment may be combined with the one or more positioning data samples in the new dataset received from the first user equipment.

FIG. 4 illustrates a flow chart according to an example embodiment of a method performed by an apparatus 800. For example, the apparatus 800 may a comprise a location management entity, such as a location management function 112 or location server, or another network entity such as a radio access network node (e.g., gNB) or a user equipment.

Referring to FIG. 4, in block 401, the apparatus receives a dataset from a first user equipment 100.

In block 402, the apparatus determines whether one or more positioning data samples in the dataset are incomplete.

For example, the one or more positioning data samples may be determined as incomplete by determining that at least one of the following is unreliable or missing in the one or more positioning data samples: at least one expected input feature or at least one expected label.

In block 403, based on determining that the one or more positioning data samples are incomplete, the apparatus determines one or more candidate user equipments 102, 102B for providing one or more entries deemed to be unreliable or missing in the one or more positioning data samples determined to be incomplete.

For example, the one or more candidate user equipments may be determined based on at least one of: a similarity of a statistic distribution of the dataset of the first user equipment and a dataset of the one or more candidate user equipments, a range between the first user equipment and the one or more candidate user equipments, or a common serving beam associated with the first user equipment and the one or more candidate user equipments.

In block 404, the apparatus transmits, to the one or more candidate user equipments 102, 102B, a request for reporting one or more measurements suitable for evaluating similarity of propagation conditions of the one or more candidate user equipments 102, 102B and the first user equipment 100.

For example, proximity of the one or more candidate user equipments 102, 102B to the target UE 100 is one way to determine the similarity of the propagation conditions. The proximity may be evaluated at the apparatus or at the or more candidate user equipments 102, 102B.

The request may indicate at least: a type of the one or more measurements, and one or more radio resources on which the one or more measurements are to be performed. For example, the one or more measurements may comprise one or more cross link interference measurements or one or more sidelink measurements associated with the first equipment.

The apparatus may receive, from the one or more candidate user equipments, a response indicating an acceptance or a rejection to the request for providing the one or more measurements. The response may further indicate a time duration during which the one or more measurements can be provided.

In block 405, the apparatus receives, from at least a subset of the one or more candidate user equipments 102, 102B (e.g., from the candidate UE(s) that accepted the request), one or more reports indicating the one or more measurements.

In block 406, the apparatus selects, based at least on the one or more reports, at least one user equipment 102 from the at least subset of the one or more candidate user equipments 102, 102B.

For example, the at least one user equipment may be selected by evaluating proximity of the at least subset of the one or more candidate user equipments to the first user equipment based on the one or more reports, the proximity being indicative of the similarity of the propagation conditions. In other words, the selected at least one user equipment may be close to the first user equipment (e.g., within a pre-defined distance from the first user equipment).

In block 407, the apparatus transmits, to the at least one user equipment 102, an indication for providing the one or more entries deemed to be unreliable or missing.

For example, the indication may indicate: a time window during which the one or more entries should be provided, and a list of the one or more entries to be provided.

In block 408, the apparatus receives, from the at least one user equipment 102, the one or more entries.

The one or more entries received from the at least one user equipment may comprise at least one of: the at least one expected input feature or the at least one expected label determined to be unreliable or missing in the one or more positioning data samples received from the first user equipment.

In block 409, the apparatus combines the one or more entries received from the at least one user equipment 102 with the one or more positioning data samples received from the first user equipment 100.

The apparatus may provide the one or more positioning data samples combined with the positioning-related data received from the at least one user equipment as training data for training a machine learning model for positioning; and estimate a position of the first user equipment or one or more other user equipments by using the trained machine learning model.

The apparatus may determine whether a dataset received from the first user equipment is irrelevant. Based on determining that the dataset received from the first user equipment is irrelevant, the apparatus may transmit, to the first user equipment, an indication to provide a new dataset; and receive the new dataset from the first user equipment. In this case, the positioning-related data received from the at least one user equipment may be combined with the one or more positioning data samples in the new dataset received from the first user equipment.

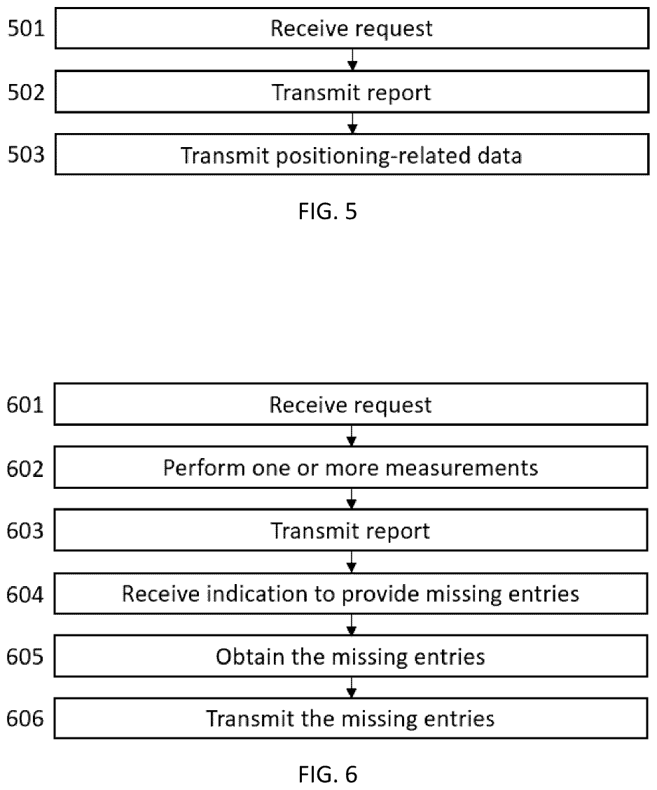

FIG. 5 illustrates a flow chart according to an example embodiment of a method performed by an apparatus 700. For example, the apparatus may be, or comprise, or be comprised in, a user equipment 102, 102B.

Referring to FIG. 5, in block 501, the apparatus receives, from a network entity (e.g., LMF 112), a request for reporting one or more measurements suitable for evaluating similarity of propagation conditions of the apparatus and a first user equipment 100.

For example, proximity of the one or more candidate user equipments 102, 102B to the target UE 100 is one way to determine the similarity of the propagation conditions. The proximity may be evaluated at the apparatus or at the network entity.

The request may indicate at least: a type of the one or more measurements, and one or more radio resources on which the one or more measurements are to be performed. For example, the one or more measurements may comprise one or more cross link interference measurements or one or more sidelink measurements associated with the first equipment.

The apparatus may determine whether to accept the request; and based on determining to accept the request, transmit, to the network entity, a response indicating an acceptance to the request for reporting the one or more measurements.

In block 502, the apparatus transmits, to the network entity 112, a report indicating the one or more measurements or an availability of the one or more measurements.

In block 503, the apparatus transmits, to the network entity 112, positioning-related data to be combined with one or more positioning data samples provided from the first user equipment 100, the positioning-related data being complementary to the one or more positioning data samples provided from the first user equipment 100.

For example, the positioning-related data may comprise one or more entries deemed to be unreliable or missing in the one or more positioning data samples provided from the first user equipment 100.

FIG. 6 illustrates a flow chart according to an example embodiment of a method performed by an apparatus 700. For example, the apparatus may be, or comprise, or be comprised in, a user equipment 102, 102B.

Referring to FIG. 6, in block 601, the apparatus receives, from a network entity (e.g., LMF 112), a request for reporting one or more measurements suitable for evaluating similarity of propagation conditions of the apparatus and the first user equipment 100.

For example, proximity of the one or more candidate user equipments 102, 102B to the target UE 100 is one way to determine the similarity of the propagation conditions. The proximity may be evaluated at the apparatus or at the network entity.

The request may indicate at least: a type of the one or more measurements, and one or more radio resources on which the one or more measurements are to be performed. For example, the one or more measurements may comprise one or more cross link interference measurements or one or more sidelink measurements associated with the first equipment.

The apparatus may determine whether to accept the request; and based on determining to accept the request, transmit, to the network entity, a response indicating an acceptance to the request for reporting the one or more measurements.

In block 602, the apparatus may perform the one or more measurements. Alternatively, the apparatus may skip performing the one or more measurements, if it has previously already obtained the one or more measurements as part of a different process.

In block 603, the apparatus transmits, to the network entity 112, a report indicating the one or more measurements.

In block 604, the apparatus receives, from the network entity 112, based on transmitting the report, an indication for providing one or more entries deemed to be unreliable or missing in one or more positioning data samples provided from the first user equipment 100.

For example, the indication may indicate: a time window during which the one or more entries should be provided, and a list of the one or more entries to be provided.

In block 605, the apparatus obtain the one or more entries based on the indication.

In block 606, the apparatus transmits, to the network entity 112, the one or more entries to be combined with the one or more positioning data samples provided from the first user equipment 100.

The blocks, related functions, and information exchanges (messages) described above by means of FIGS. 3-6 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

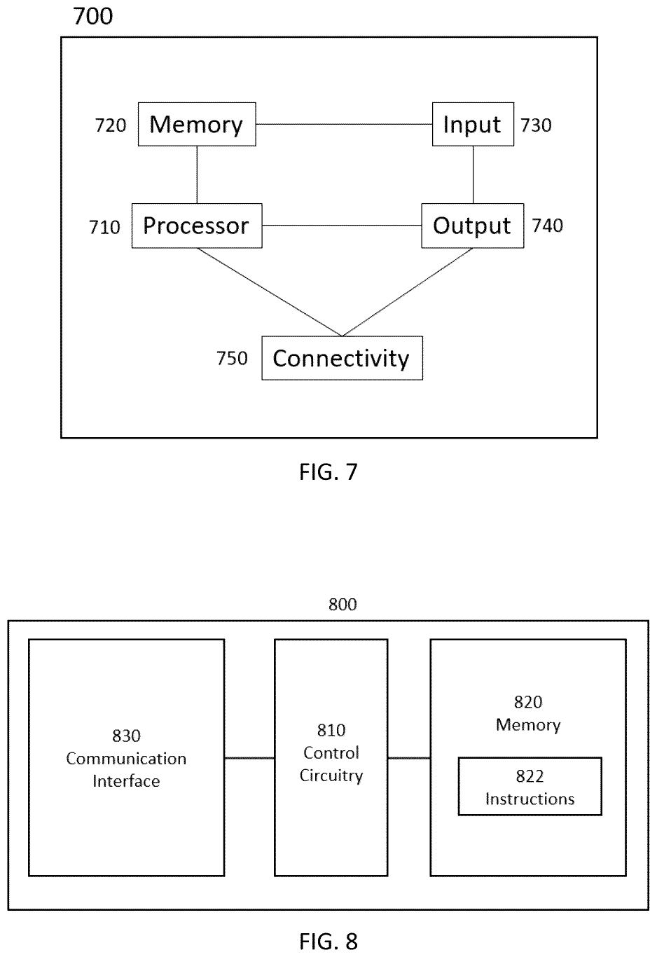

FIG. 7 illustrates an example of an apparatus 700 comprising means for performing one or more of the example embodiments described above. For example, the apparatus 700 may be an apparatus such as, or comprising, or comprised in, a user device. The user device may also be called a wireless communication device, a subscriber unit, a mobile station, a remote terminal, an access terminal, a user terminal, a terminal device, or user equipment (UE). The user device may correspond to one of the UEs 100, 102 of FIG. 1A.

The apparatus 700 may comprise a circuitry or a chipset applicable for realizing one or more of the example embodiments described above. For example, the apparatus 700 may comprise at least one processor 710. The at least one processor 710 interprets instructions (e.g., computer program instructions) and processes data. The at least one processor 710 may comprise one or more programmable processors. The at least one processor 710 may comprise programmable hardware with embedded firmware and may, alternatively or additionally, comprise one or more application-specific integrated circuits (ASICs).

The at least one processor 710 is coupled to at least one memory 720. The at least one processor is configured to read and write data to and from the at least one memory 720. The at least one memory 720 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 720 stores computer readable instructions that are executed by the at least one processor 710 to perform one or more of the example embodiments described above. For example, non-volatile memory stores the computer readable instructions, and the at least one processor 710 executes the instructions using volatile memory for temporary storage of data and/or instructions. The computer readable instructions may refer to computer program code.

The computer readable instructions may have been pre-stored to the at least one memory 720 or, alternatively or additionally, they may be received, by the apparatus, via an electromagnetic carrier signal and/or may be copied from a physical entity such as a computer program product. Execution of the computer readable instructions by the at least one processor 710 causes the apparatus 700 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 700 may further comprise, or be connected to, an input unit 730. The input unit 730 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 730 may comprise an interface to which external devices may connect to.

The apparatus 700 may also comprise an output unit 740. The output unit may comprise or be connected to one or more displays capable of rendering visual content, such as a light emitting diode (LED) display, a liquid crystal display (LCD) and/or a liquid crystal on silicon (LCoS) display. The output unit 740 may further comprise one or more audio outputs. The one or more audio outputs may be for example loudspeakers.

The apparatus 700 further comprises a connectivity unit 750. The connectivity unit 750 enables wireless connectivity to one or more external devices. The connectivity unit 750 comprises at least one transmitter and at least one receiver that may be integrated to the apparatus 700 or that the apparatus 700 may be connected to. The at least one transmitter comprises at least one transmission antenna, and the at least one receiver comprises at least one receiving antenna. The connectivity unit 750 may comprise an integrated circuit or a set of integrated circuits that provide the wireless communication capability for the apparatus 700. Alternatively, the wireless connectivity may be a hardwired application-specific integrated circuit (ASIC). The connectivity unit 750 may also provide means for performing at least some of the blocks or functions of one or more example embodiments described above. The connectivity unit 750 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 700 may further comprise various components not illustrated in FIG. 7. The various components may be hardware components and/or software components.

FIG. 8 illustrates an example of an apparatus 800 comprising means for performing one or more of the example embodiments described above. For example, the means may be a location management function 112 of the core network 110, or a location server, or another network entity such as a radio access network node (e.g., gNB) or a user equipment, or the means may be network function virtualization infrastructure.

The apparatus 800 may comprise, for example, a circuitry or a chipset applicable for realizing one or more of the example embodiments described above. The apparatus 800 may be an electronic device or computing system comprising one or more electronic circuitries. The apparatus 800 may comprise a control circuitry 810 such as at least one processor, and at least one memory 820 storing instructions 822 which, when executed by the at least one processor, cause the apparatus 800 to carry out one or more of the example embodiments described above. The instructions 822 may comprise instructions of the AMF. Such instructions 822 may, for example, include computer program code (software). The at least one processor and the at least one memory storing the instructions may provide the means for providing or causing the performance of any of the methods and/or blocks described above.

The processor is coupled to the memory 820. The processor is configured to read and write data to and from the memory 820. The memory 820 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 820 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 820 or, alternatively or additionally, they may be received, by the apparatus, via an electromagnetic carrier signal and/or may be copied from a physical entity such as a computer program product. Execution of the computer readable instructions causes the apparatus 800 to perform one or more of the functionalities described above.

The memory 820 may be implemented using any suitable data storage technology, such as semiconductor-based memory devices, flash memory, magnetic memory devices and systems, optical memory devices and systems, fixed memory and/or removable memory.

The apparatus 800 may further comprise or be connected to a communication interface 830 comprising hardware and/or software for realizing communication connectivity according to one or more communication protocols. The communication interface 830 may comprise at least one transmitter (Tx) and at least one receiver (Rx) that may be integrated to the apparatus 800 or that the apparatus 800 may be connected to. The communication interface 830 may provide means for performing some of the blocks for one or more example embodiments described above. The communication interface 830 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 830 provides the apparatus with communication capabilities to communicate in the wireless communication network. The communication interface 830 may, for example, provide a radio, cable or fiber interface to one or more network nodes of a radio access network.

It is to be noted that the apparatus 800 may further comprise various components not illustrated in FIG. 8. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the embodiments.

1. An apparatus comprising at least one processor, and at least one memory storing instructions that, when executed by the at least one processor, cause the apparatus at least to:
transmit, to one or more candidate user equipments, a request for reporting one or more measurements suitable for evaluating similarity of propagation conditions of the one or more candidate user equipments and a first user equipment;
receive, from at least a subset of the one or more candidate user equipments, one or more reports indicating the one or more measurements or an availability of the one or more measurements;
select, based at least on the one or more reports, at least one user equipment from the at least subset of the one or more candidate user equipments;
receive, from the at least one user equipment, positioning-related data that is complementary to one or more positioning data samples received from the first user equipment; and
combine the positioning-related data received from the at least one user equipment with the one or more positioning data samples received from the first user equipment.

2. The apparatus according to claim 1, wherein the at least one user equipment is selected by evaluating proximity of the at least subset of the one or more candidate user equipments to the first user equipment based on the one or more reports, the proximity being indicative of the similarity of the propagation conditions.

3. The apparatus according to any preceding claim, wherein the positioning-related data received from the at least one user equipment comprises one or more entries deemed to be unreliable or missing in the one or more positioning data samples received from the first user equipment.

4. The apparatus according to claim 3, further being caused to:
receive a dataset from the first user equipment;
determine whether the one or more positioning data samples in the dataset are incomplete;
based on determining that the one or more positioning data samples are incomplete, determine the one or more candidate user equipments for providing the one or more entries deemed to be unreliable or missing in the one or more positioning data samples determined to be incomplete; and
transmit, to the at least one user equipment, an indication for providing the one or more entries deemed to be unreliable or missing.

5. The apparatus according to claim 4, wherein the one or more positioning data samples are determined as incomplete by determining that at least one of the following is unreliable or missing in the one or more positioning data samples: at least one expected input feature or at least one expected label,
wherein the one or more entries received from the at least one user equipment comprise at least one of: the at least one expected input feature or the at least one expected label determined to be unreliable or missing in the one or more positioning data samples received from the first user equipment.

6. The apparatus according to any of claims 4-5, wherein the one or more candidate user equipments are determined based on at least one of:
a similarity of a statistic distribution of the dataset of the first user equipment and a dataset of the one or more candidate user equipments,
a range between the first user equipment and the one or more candidate user equipments, or
a common serving beam associated with the first user equipment and the one or more candidate user equipments.

7. The apparatus according to any of claims 4-6, wherein the indication indicates:
a time window during which the one or more entries should be provided, and
a list of the one or more entries to be provided.

8. The apparatus according to any preceding claim, further being caused to:
receive, from the one or more candidate user equipments, a response indicating an acceptance or a rejection to the request for providing the one or more measurements.

9. The apparatus according to claim 8, wherein the response further indicates a time duration during which the one or more measurements can be provided.

10. The apparatus according to any preceding claim, wherein the request indicates at least:
a type of the one or more measurements, and
one or more radio resources on which the one or more measurements are to be performed.

11. The apparatus according to any preceding claim, wherein the one or more measurements comprise one or more cross link interference measurements or one or more sidelink measurements associated with the first equipment.

12. The apparatus according to any preceding claim, wherein the at least one user equipment is selected from the at least subset of the one or more candidate user equipments based on a cross link interference reference signal received power measurement reported from the at least one user equipment being above a threshold.

13. The apparatus according to any preceding claim, further being caused to:
determine whether a dataset received from the first user equipment is irrelevant;
based on determining that the dataset received from the first user equipment is irrelevant, transmit, to the first user equipment, an indication to provide a new dataset; and
receive the new dataset from the first user equipment,
wherein the positioning-related data received from the at least one user equipment is combined with the one or more positioning data samples in the new dataset received from the first user equipment.

14. The apparatus according to any preceding claim, further being caused to:
provide the one or more positioning data samples combined with the positioning-related data received from the at least one user equipment as training data for training a machine learning model for positioning; and
estimate a position of the first user equipment or one or more other user equipments by using the trained machine learning model.

15. An apparatus comprising at least one processor, and at least one memory storing instructions that, when executed by the at least one processor, cause the apparatus at least to:
receive, from a network entity, a request for reporting one or more measurements suitable for evaluating similarity of propagation conditions of the apparatus and a first user equipment;
transmit, to the network entity, a report indicating the one or more measurements or an availability of the one or more measurements; and
transmit, to the network entity, positioning-related data to be combined with one or more positioning data samples provided from the first user equipment, the positioning-related data being complementary to the one or more positioning data samples provided from the first user equipment.

16. The apparatus according to claim 15, further being caused to:
receive, from the network entity, based on transmitting the report, an indication for providing the positioning-related data,
wherein the positioning-related data comprises one or more entries deemed to be unreliable or missing in the one or more positioning data samples provided from the first user equipment.

17. The apparatus according to any of claims 15-16, further being caused to:
determine whether to accept the request; and
based on determining to accept the request, transmit, to the network entity, a response indicating an acceptance to the request for reporting the one or more measurements.

18. A method comprising:
transmitting, to one or more candidate user equipments, a request for reporting one or more measurements suitable for evaluating similarity of propagation conditions of the one or more candidate user equipments and a first user equipment;
receiving, from at least a subset of the one or more candidate user equipments, one or more reports indicating the one or more measurements or an availability of the one or more measurements;
selecting, based at least on the one or more reports, at least one user equipment from the at least subset of the one or more candidate user equipments;
receiving, from the at least one user equipment, positioning-related data that is complementary to one or more positioning data samples received from the first user equipment; and
combining the positioning-related data received from the at least one user equipment with the one or more positioning data samples received from the first user equipment.

19. A method comprising:
receiving, by an apparatus, from a network entity, a request for reporting one or more measurements suitable for evaluating similarity of propagation conditions of the apparatus and a first user equipment;
transmitting, by the apparatus, to the network entity, a report indicating the one or more measurements or an availability of the one or more measurements; and
transmitting, by the apparatus, to the network entity, positioning-related data to be combined with one or more positioning data samples provided from the first user equipment, the positioning-related data being complementary to the one or more positioning data samples provided from the first user equipment.

20. A non-transitory computer readable medium comprising program instructions which, when executed by an apparatus, cause the apparatus to perform at least the following:
transmitting, to one or more candidate user equipments, a request for reporting one or more measurements suitable for evaluating similarity of propagation conditions of the one or more candidate user equipments and a first user equipment;
receiving, from at least a subset of the one or more candidate user equipments, one or more reports indicating the one or more measurements or an availability of the one or more measurements;
selecting, based at least on the one or more reports, at least one user equipment from the at least subset of the one or more candidate user equipments;
receiving, from the at least one user equipment, positioning-related data that is complementary to one or more positioning data samples received from the first user equipment; and
combining the positioning-related data received from the at least one user equipment with the one or more positioning data samples received from the first user equipment.

21. A non-transitory computer readable medium comprising program instructions which, when executed by an apparatus, cause the apparatus to perform at least the following:
receiving, from a network entity, a request for reporting one or more measurements suitable for evaluating similarity of propagation conditions of the apparatus and a first user equipment;
transmitting, to the network entity, a report indicating the one or more measurements or an availability of the one or more measurements; and
transmitting, to the network entity, positioning-related data to be combined with one or more positioning data samples provided from the first user equipment, the positioning-related data being complementary to the one or more positioning data samples provided from the first user equipment.
